(19) United States
(12) Patent Application Publication
(10) Pub. No.: US 2003/0060080 A1
(43) Pub. Date: Mar. 27, 2003

(54) Connector for an audio/visual display monitor

(76) Inventor: Ian Paul Rees, Surrey (GB)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/232,762

(22) Filed: Aug. 30, 2002

(30) Foreign Application Priority Data
Aug. 30, 2001 (GB) 0121005.3

(51) Int. Cl. H01R 11/00

(52) U.S. Cl. 439/502

(57) ABSTRACT

A connector for connecting a decoder to an audio/visual display remote monitor having a screen comprises a cable conforming to CAT5 protocol and a junction box at one end portion thereof for connecting to an electrical input, an audio/video input and an infrared input whereby control of the decoder can be effected by a remote controller directing infrared signals to a receptor of the monitor.

### BACKGROUND

1. Technical Field

The present invention relates generally to connectors and, more particularly, to a connector for an audio/visual display monitor.

2. Related Art

It is known to provide cables which conform to CAT5 protocol for supplying telecommunications signals from a source to different locations. Such an arrangement may be provided in a building so that telecommunications signals can be linked to terminals in different rooms of the building whereby a receiver may be connected to any one of the terminals so as to receive signals transmitted thereto by a corresponding one of the cables. According to the CAT5 protocol, a cable would comprise eight twin conductors.

Generally, receivers require a source of electrical power and this presents a problem if the electrical power required and the environment in which it is received would be such as to be a danger to human life.

It would be undesirable, for example, to provide a television receiver in a bathroom since, unless the receiver were to be completely sealed, any moisture could cause short circuiting of voltage through wet surfaces which may be touched, with the risk of life threatening consequences and a danger to human life.

However, there is a demand for providing television receivers in areas where there is a likelihood of exposure to moisture, such as in bathrooms and kitchens.

### SUMMARY

Accordingly, it is desirable to provide a system whereby viewing of television is possible in areas likely to be exposed to moisture without risk to human life.

It is also desirable to provide a television monitor which, in use, is flush with a wall and which is sealed against moisture.

According to the present invention, there is provided a connector for an audio/visual display monitor comprising a cable conforming to CAT5 protocol, a junction box provided at one end portion of the cable for connecting a first conductor of the cable to an electrical power source, a second conductor of the cable to an audio signal input, a third conductor of the cable to a video signal input and a fourth conductor of the cable to a signal controller and terminal means provided at a remote end portion of the cable whereby the connector is adapted to be connected to the monitor.

### BRIEF DESCRIPTION OF THE DRAWING

FIG. 1 is a diagrammatic representation of one exemplary embodiment of a connector in accordance with the principles of the present invention.

### DETAILED DESCRIPTION

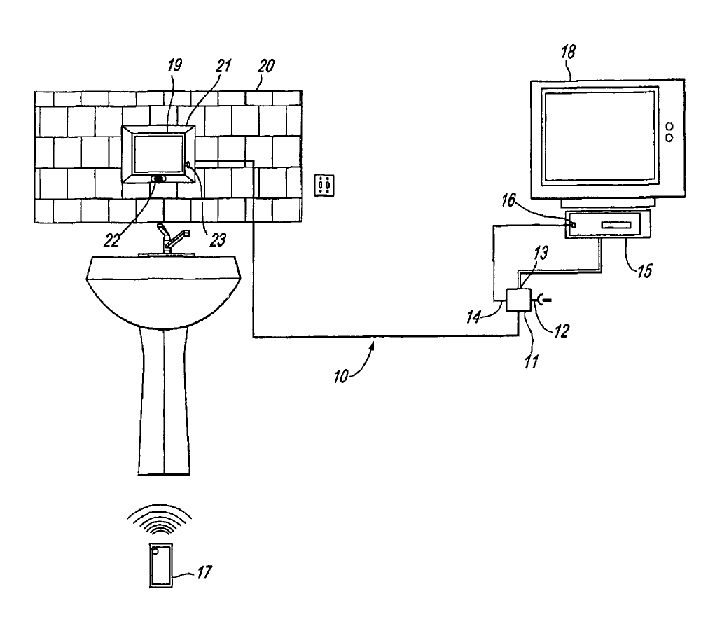

By way of example only, FIG. 1 illustrates a connector 10 which conforms to CAT5 protocol in that it comprises eight pairs of twin conductors, one end portion of the connector being provided with a junction box 11, and a remote end portion of the connector 10 being provided with the terminal (not shown).

The junction box 11 is adapted to receive a 12 volt electrical input 12, an audio/video input 13 and an infrared input 14. The audio/video input 13 is connected to a decoder 15 which is adapted to receive signals from an antenna (not shown). The infrared input 14 is connected to an output 16 of the decoder 15, the output 16 being included in a control circuit (not shown) for controlling selection of television programmes and sound and video characteristics. The circuit may be operated from a remote controller 17. The decoder 15 is connected to a television receiver 18.

The remote terminal of the connector 10 is received in a socket (not shown) of a back box (not shown) located behind a thin film technology (TFT) audio/visual display monitor screen 19 which is inset in a wall 20 of a bathroom so that an outer surface of the screen 19 is flush with an outer surface of the wall 20. The screen 19 is surrounded by a bezel 21 which includes a speaker 22 and a receptor 23 for receiving signals from the remote controller 17.

The arrangement is such that one pair of conductors of the connector 10 provides audio signals, a second pair of the conductors provides video signals, a third of the conductors provides a voltage and a fourth pair of the conductors provides an infrared signal for controlling operation of the control circuit in the decoder 15.

Therefore, power is supplied to the screen 19, as are audio/video signals from the decoder 15. The audio/video signals are selectively controlled by operation of the decoder 15 controlled by the remote controller 17. The decoder 15 and the television receiver 18 would be located in, for example, a living area separate from the bathroom.

However the audio/video signals received by the television receiver 18 may also be received by the remote audio/visual display monitor upon operation of the remote controller 17 to produce signals incident on the receptor 23. The receptor 23 thus receives infrared signals from the remote controller 17 and the signals are relayed through the connector 10 and the junction box 11 to the decoder 15 so as to control the decoder 15 to operate the operating circuit in the decoder to provide audio/video signals from the decoder 15 back to the audio/video input 13 and to the audio/visual display monitor.

In this manner, a connector in accordance with the present invention provides a means for connecting a decoder to a remote audio/visual display monitor without the necessity of also providing power to the monitor at a voltage which would be dangerous to human life.

The connector 10 may be provided with a balun (not shown) for altering the impedance characteristics and balancing the signal.

Since the remote audio/visual display monitor only requires means for connecting to the connector, only a small recess is required in a wall within which to locate the monitor. Therefore, the monitor is locatable in most bathroom walls such as to be flush with any such wall and sealed against moisture.

The foregoing description is for the purpose of teaching those skilled in the art the best mode of carrying out the invention and is intended to be illustrative only. Numerous modifications and alternative embodiments of the invention will be apparent to those skilled in the art in view of this description, and the disclosed embodiments may be varied substantially without departing from the spirit of the invention. Accordingly, the exclusive use of all modifications within the scope of the appended claims is reserved.

What is claimed is:

1. A connector for an audio/visual display monitor, comprising:
a cable conforming to CAT5 protocol;
a junction box provided at one end portion of the cable for connecting first conductors of the cable to an electrical power source, second conductors of the cable to an audio signal input, third conductors of the cable to a video signal input and fourth conductors of the cable to a signal controller; and
terminal means provided at a remote end portion of the cable;
whereby the connector is adapted to be connected to the monitor.

2. A connector as claimed in claim 1, wherein the connector includes a balun.

3. A connector as claimed in claim 1, wherein the signal controller is a decoder connected to a television receiver.

4. A connector as claimed in claim 3, wherein the monitor is provided with a receptor and a remote controller is adapted to control the operation of the monitor.

5. A connector as claimed in claim 4, wherein the controller is adapted to control the operation of the monitor through the decoder.
